(19) United States
(12) Patent Application Publication
(10) Pub. No.: US 2016/0082806 A1
(43) Pub. Date: Mar. 24, 2016

(54) AIR-CONDITIONING SYSTEM FOR VEHICLE

(71) Applicants: Hyundai Motor Company, Seoul (KR); Kia Motors Corp., Seoul (KR)

(72) Inventor: June Kyu PARK, Hwaseong-si (KR)

(73) Assignees: Hyundai Motor Company, Seoul (KR); Kia Motors Corp., Seoul (KR)

(21) Appl. No.: 14/559,280

(22) Filed: Dec. 3, 2014

(30) Foreign Application Priority Data
Sep. 22, 2014 (KR) 10-2014-0125794

(51) Int. Cl. B60H 1/00

(52) U.S. Cl. CPC B60H 1/00478

(57) ABSTRACT

An air-conditioning system for a vehicle may include an air-conditioning duct and a thermoelectric module. The air-conditioning duct may have a first side communicating with an interior of the vehicle and a second side divided into a first line and a second line, the first line communicating with a roof surface to allow air to flow and the second line communicating with an outdoor space of the vehicle. The thermoelectric module may be divided into an air-conditioning side and a heat-dissipating side, the air-conditioning side being disposed at a side of the first line and the heat-dissipating side being disposed at a side of the second line.

### CROSS REFERENCE TO RELATED APPLICATION

The present application claims priority of Korean Patent Application Number 10-2014-0125794 filed Sep. 22, 2014, the entire contents of which are incorporated herein for all purposes by this reference.

### BACKGROUND OF THE INVENTION

1. Field of the Invention

The present invention, in general, relates to an air-conditioning system for a vehicle, and, more particularly, to an air-conditioning system for a vehicle that improves air-conditioning performance using a small amount of energy by discharging conditioned-air toward passengers in the back seats by locally controlling the air around the passengers.

2. Description of the Related Art

Today, in vehicles, the air conditioned and discharged by the heater/air-conditioning system for the front seats is sent to the back seats to supply conditioned-air to the passengers in the back seats.

However, air conditioning the back seats is generally less effective than air conditioning the front seats and the air cooled and discharged by the air-conditioning system fails to sufficiently reach the back seats.

Accordingly, air-conditioning systems have been equipped with an additional heater (cooling water)/air-conditioning (refrigerant) system in some cases to improve temperature/amount of wind for the back seats and to implement various control logics.

However, although those air-conditioning systems can improve the cooling/heating ability for the back seats, it is difficult to install cooling water and refrigerant pipes. Further, since the air-conditioning systems cool and heat the entire air in the vehicles, there is a problem in that the energy discharged out of the vehicles is wasted, rather than cooling/heating passengers.

The information disclosed in this Background section is only for enhancement of understanding of the general background of the invention and should not be taken as an acknowledgement or any form of suggestion that this information forms the prior art already known to a person skilled in the art.

### SUMMARY OF THE INVENTION

Accordingly, the present invention has been made keeping in mind the above problems occurring in the related art and/or other problems, and the present invention is intended to provide an air-conditioning system for a vehicle that improves air-conditioning performance using a small amount of energy by discharging conditioned-air toward passengers in the back seats by locally controlling the air around the passengers.

According to various aspects of the present invention, there is provided an air-conditioning system for a vehicle that includes: an air-conditioning duct having a first side communicating with an interior of the vehicle and a second side divided into a first line and a second line, the first line communicating with a roof surface to allow air to flow and the second line communicating with an outdoor space of the vehicle; and a thermoelectric module divided into an air-conditioning side and a heat-dissipating side, the air-conditioning side being disposed at a side of the first line and the heat-dissipating side being disposed at a side of the second line.

An intake port may be formed at a predetermined portion of the roof surface and the first side of the air-conditioning duct may be connected to the intake port to take air from the interior of the vehicle. The air-conditioning duct may be disposed between the roof surface and a roof panel.

A discharge port may be formed on a back seat roof surface and a second end of the first line may be connected to the discharge port, so the air flows into a space around back seats.

A discharge space having a closed cross-section that communicates with the outdoor space of the vehicle may be defined at a car body panel forming an edge of the roof surface and the second side of the second line may be connected to the discharge space through the car body panel, so the air flows to the outdoor space. A rear end of the car body panel may extend to a luggage room and the discharge space may be connected to an inside of the luggage room.

A blower rotating to suck the air from the interior of the vehicle at the first side of the air-conditioning duct and discharge the sucked air to the second side of the air-conditioning duct may be disposed in the air-conditioning duct.

According to the present invention, since the conditioned-air sucked into the air-conditioning duct and flowing in the first line is discharged toward the head of a passenger through the roof surface, the cooling performance that the passenger feels is improved using a small amount of energy by locally discharging the air to the passenger. In particular, the conditioned-air is discharged toward the passenger over the passenger's head in the back seat, such that it is possible to improve the performance of cooling the space around the back seats even without an additional complicated structure using cooling water/refrigerant pipes.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view showing an exemplary air-conditioning duct according to the present invention mounted on the roof of a vehicle;

FIG. 2 is a view showing an exemplary air-conditioning duct according to the present invention seen from the bottom;

FIG. 3 is a view illustrating discharging of cooling air to a passenger through the air-conditioning duct of FIG. 1;

FIG. 4A is a view illustrating the combination relationship between an exemplary air-conditioning duct and an exemplary thermoelectric module according to the present invention;

FIG. 4B is a partially enlarged view of FIG. 4A;

FIG. 5A is a view illustrating the configuration for discharging air dissipating heat through the air-conditioning duct according to the present invention; and

FIG. 5B is a partially enlarged view of FIG. 5A.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An air-conditioning system for a vehicle of the present invention includes an air-conditioning duct 10 and a thermoelectric module 20.

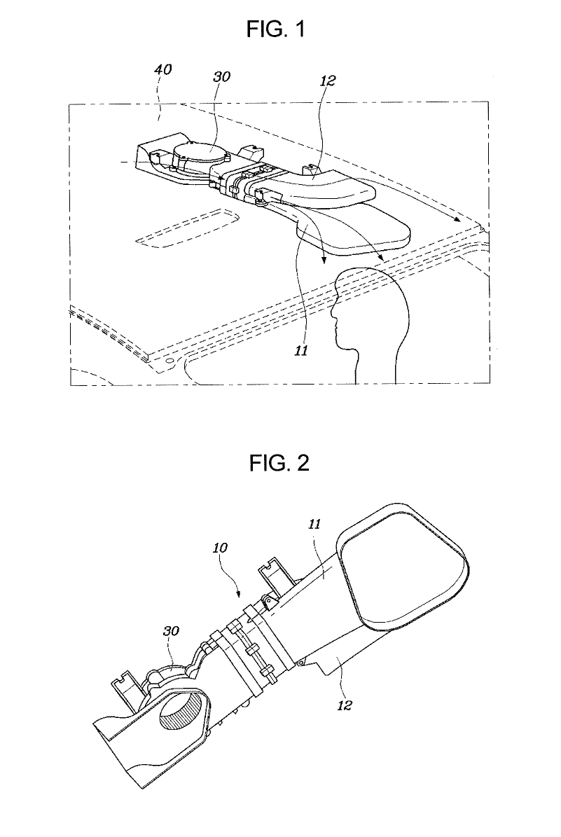

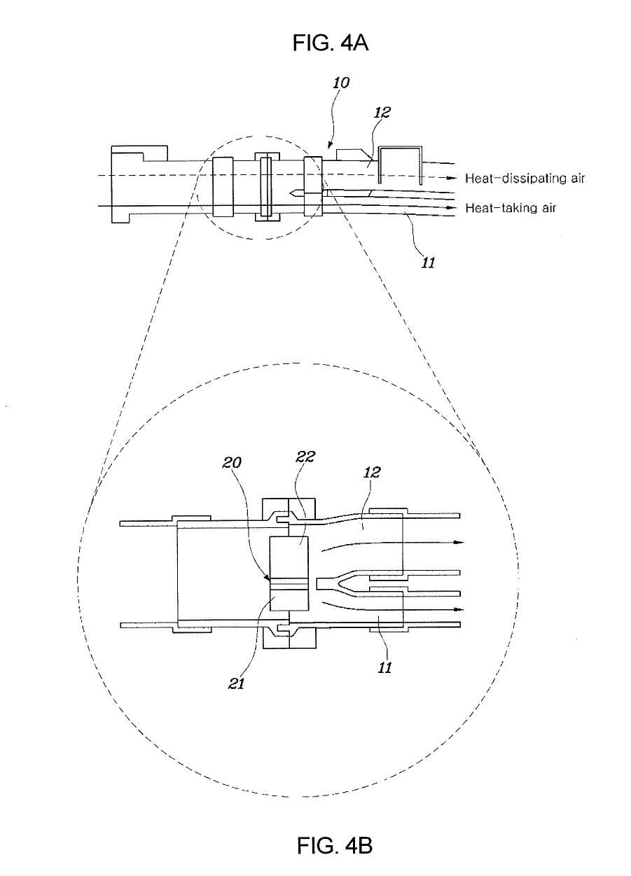

The present invention is described in detail with reference to FIGS. 1 to 4B. First, the air-conditioning duct 10 has a first side that communicates with the interior of a vehicle and a second side that communicates with a roof surface 41 and an outdoor space of the vehicle to allow for airflow.

For example, the air-conditioning duct 10 is divided into a first line 11 and a second line 12 toward the second side from the middle portion such that the first line 11 communicates with the roof surface 41 over a passenger and the second line 12 communicates with an outdoor space of the vehicle to allow for airflow. The first line 11 and the second line 12 are independent ducts having a closed cross-section and air can flow through the lines.

The thermoelectric module 20 has an air-conditioning side 21 and a heat-dissipating side 22. The air-conditioning side 21 is disposed at a side of the first line 11 and the heat-dissipating side 22 is disposed at a side of the second line 12.

That is, the thermoelectric module 20 functions as a heat sink that transmits heat from one side to the other side, when electricity is applied, so it is divided into the air-conditioning side 21 and the heat-dissipating side 22. Further, the thermoelectric module 20 is disposed ahead of the diverging point of the first line 11 and the second line 12 in the air-conditioning duct 10.

Accordingly, air sucked in the air-conditioning duct 10 exchanges heat with the air-conditioning side 21 and the heat-dissipating side 22 and then flows into the first line 11 and the second line 12. Heat-dissipating air flowing in the second line 12 is discharged to an outdoor space of the vehicle, and particularly, conditioned-air flowing in the first line 11 is discharged toward the head of a passenger through the roof surface 41. Accordingly, air is locally discharged toward a passenger and the cooling performance that the passenger feels is greatly improved.

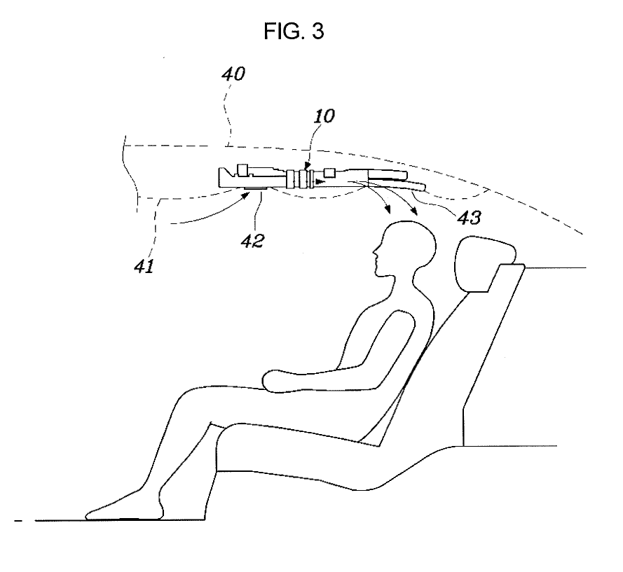

Further, as shown in FIGS. 1 and 3, according to the present invention, an intake port 42 is formed at a portion of the roof surface 41 and the first side of the air-conditioning duct 10 is connected to the intake port 42, so air can flow into the air-conditioning duct from the interior of the vehicle. For example, the intake port 42 may be formed on the roof surface 41 between the front seats and the back seats.

Further, the air-conditioning duct 10 may be disposed between the roof surface 41 and a roof panel 40. That is, interior air that has been primarily conditioned through a main air-conditioning system flows into the air-conditioning duct 10 through the intake port 42, exchanges heat, and is then discharged to a passenger, such that the cooling performance that the passenger feels is improved.

In particular, according to the present invention, a discharge port 43 may be formed on the back seat roof surface 41 over a passenger and the second side of the first line 11 is connected to the discharge port 43, so air can flow into the space around the back seats.

That is, the air conditioned through the thermoelectric module 20 is discharged toward a passenger in the back seat from above the passenger's head, so the performance of cooling the space around the back seats is improved even without an additional complicated structure using cooling/refrigerant pipes.

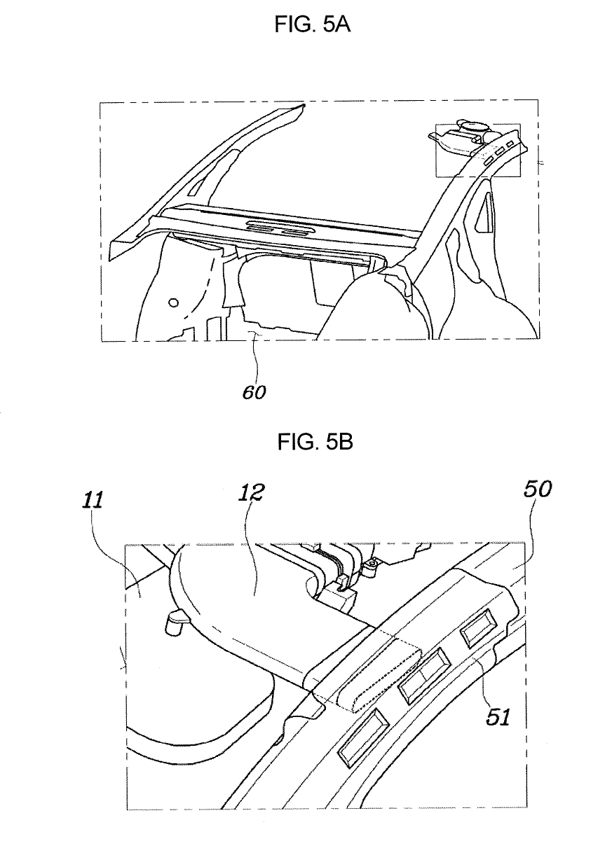

Referring to FIG. 5A and FIG. 5B, according to the present invention, a car body panel 50 is disposed to form the edge of the roof surface 41 and a discharge space having a closed cross-section that communicates with an outdoor space of the vehicle is defined at the car body panel 50. Further, the second side of the second line 12 is connected to the discharge space through the car body panel 50, so air can flow to an outdoor space.

For example, a shield panel 51 covers the car body panel 50, so that the discharge space can be defined between the car body panel 50 and the shield panel 51. Further, the side of the second line 12 of the duct is disposed through the car body panel 50, so that the second line 12 and the discharge space can be connected to each other.

In particular, the rear end of the car body panel 50 extends to a luggage room 60, so the discharge space can be connected to the inside of the luggage room 60. The car body panel 50 may be a C-pillar extending from a side of the roof surface 41 and to a side of the luggage room 60.

According to this or similar configuration, the heat-dissipating air flowing into the second line 12 after exchanging heat through the thermoelectric module 20 flows into the outdoor space in the luggage room 60 through the discharge space.

As shown in FIGS. 1 and 2, a blower 30 rotating to suck air from the interior of the vehicle at the first side of the air-conditioning duct 10 and discharge the sucked air to the second side of the air-conditioning duct 10 may be disposed in the air-conditioning duct 10. For example, the blower 30 may be disposed ahead of the thermoelectric module 20 and may be disposed in the intake port 42.

For convenience in explanation and accurate definition in the appended claims, the terms “front” or “rear”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An air-conditioning system for a vehicle, comprising:
an air-conditioning duct having a first side communicating with an interior of the vehicle and a second side divided into a first line and a second line, the first line communicating with a roof surface to allow air to flow and the second line communicating with an outdoor space of the vehicle; and
a thermoelectric module divided into an air-conditioning side and a heat-dissipating side, the air-conditioning side being disposed at a side of the first line and the heat-dissipating side being disposed at a side of the second line.

2. The air-conditioning system of claim 1, wherein an intake port is formed at a predetermined portion of the roof surface and the first side of the air-conditioning duct is connected to the intake port to take air from the interior of the vehicle.

3. The air-conditioning system of claim 1, wherein the air-conditioning duct is disposed between the roof surface and a roof panel.

4. The air-conditioning system of claim 1, wherein a discharge port is formed on a back seat roof surface and a second end of the first line is connected to the discharge port, so the air flows into a space around back seats.

5. The air-conditioning system of claim 1, wherein a discharge space having a closed cross-section that communicates with the outdoor space of the vehicle is defined at a car body panel forming an edge of the roof surface and the second side of the second line is connected to the discharge space through the car body panel, so the air flows to the outdoor space.

6. The air-conditioning system of claim 5, wherein a rear end of the car body panel extends to a luggage room and the discharge space is connected to an inside of the luggage room.

7. The air-conditioning system of claim 1, wherein a blower rotating to suck the air from the interior of the vehicle at the first side of the air-conditioning duct and discharge the sucked air to the second side of the air-conditioning duct is disposed in the air-conditioning duct.
